(19) United States
(12) Patent Application Publication
(10) Pub. No.: US 2025/0155703 A1
(43) Pub. Date: May 15, 2025

(54) DETERMINATION METHOD FOR ACHROMATIC METALENS, ACHROMATIC METALENS, AND APPLICATION ASSEMBLY THEREOF

(71) Applicant: Hangzhou Najing Technology Co., LTD, Hangzhou (CN)

(72) Inventors: Yongxing GONG, Hangzhou (CN); Xingyi LI, Hangzhou (CN); Leyi HOU, Hangzhou (CN); Yuanyuan XING, Hangzhou (CN)

(73) Assignee: Hangzhou Najing Technology Co., LTD, Hangzhou (CN)

(21) Appl. No.: 19/021,292

(22) Filed: Jan. 15, 2025

Related U.S. Application Data
(63) Continuation of application No. PCT/CN2024/108756, filed on Jul. 31, 2024.

(30) Foreign Application Priority Data
Aug. 1, 2023 (CN) 202310955862.9

(51) Int. Cl. G02B 27/00; B82Y 20/00; G02B 1/00

(52) U.S. Cl. CPC G02B 27/0012; B82Y 20/00; G02B 1/002; G02B 2207/101

(57) ABSTRACT

A determination method for an achromatic metalens, an achromatic metalens, and an application assembly thereof are provided. The metalens includes a metasurface, and the method includes: obtaining a nano-structure parameter library, where the nano-structure parameter library includes: at least one piece of nano-structure unit information; establishing a forward propagation model according to the nano-structure parameter library, and utilizing the forward propagation model for simulating a process in which incident light passes through the metalens to obtain a propagation result; determining phase plane arrangement of the metasurface according to the propagation result and a preset evaluation rule; and matching the phase plane arrangement with each group of the nano-structure unit information in the nano-structure parameter library to determine structure information of a nano-structure unit adopted correspondingly at each position on the metasurface.

### CROSS REFERENCE TO THE RELATED APPLICATIONS

The present application is a continuation application of International Application No. PCT/CN2024/108756, filed on Jul. 31, 2024, which is based upon and claims priority to Chinese Patent Application No. 202310955862.9 filed on Aug. 1, 2023, the entire contents of which are incorporated herein by reference.

### TECHNICAL FIELD

The present disclosure relates to the field of lenses, and in particular to a determination method for an achromatic metalens, an achromatic metalens, and an application assembly thereof.

### BACKGROUND

As a new type of artificial material, a metasurface can realize high-efficiency adjustment and control for various parameters (such as, frequency, an amplitude, a phase, polarization, etc.) of light at a sub-wavelength scale through arrangement of nano-structures on a substrate. A lens designed by means of a metasurface material, that is, a metalens, has characteristics of a small thickness and a light weight compared with a traditional optical lens. A plurality of lenses may be simplified into a one-layer metasurface structure, so that integration and miniaturization for a lens imaging system are benefited.

However, the metalens may introduce a large chromatic aberration, thereby influencing its use effect. With regard to this problem, a correction method for a chromatic aberration of a metalens in the related literature includes: the chromatic aberration of a metasurface is compensated by means of nano-structure group delay. However, for an achromatic metalens with a high numerical aperture, a higher group delay is required to realize compensation for a chromatic aberration, and the higher group delay corresponds to nano-structures with larger high aspect ratio and more complex shape, so that the achromatic metalens with the high numerical aperture is more difficult.

### SUMMARY

The present disclosure provides a determination method for an achromatic metalens, an achromatic metalens, and an application assembly thereof, in order to solve the above technical problems existing in the related literature.

In a first aspect, an embodiment of the present disclosure provides a determination method for an achromatic metalens, the achromatic metalens includes a metasurface, and the determination method includes:
obtaining a nano-structure parameter library; the nano-structure parameter library includes: at least one piece of nano-structure unit information;
establishing a forward propagation model according to the nano-structure parameter library, and utilizing the forward propagation model for simulating a process in which incident light passes through the achromatic metalens to obtain a propagation result; the propagation result includes: at least one electric field component of the incident light at a first designated position;
determining phase plane arrangement of the metasurface according to the propagation result and a preset evaluation rule; and
matching the phase plane arrangement with each group of the nano-structure unit information in the nano-structure parameter library to determine structure information of a nano-structure unit adopted correspondingly at each position on the metasurface.

In an example, each piece of the nano-structure unit information may include:
the structure information of the nano-structure unit; and
a phase and a transmittance of the nano-structure unit under incidence with different wavelengths;
the structure information may include: a geometry size and a shape of the nano-structure unit.

In an example, the step of establishing the forward propagation model according to the nano-structure parameter library, and utilizing the forward propagation model for simulating the process in which the incident light passes through the achromatic metalens to obtain the propagation result may include:
establishing scattering field distribution of each nano-structure unit at different wavelengths of the incident light according to a phase and a transmittance of each nano-structure unit in the nano-structure parameter library;
establishing the forward propagation model according to the scattering field distribution of each nano-structure unit at different wavelengths of the incident light; and
adopting a Green function method, utilizing the forward propagation model for simulating the process in which the incident light passes through the achromatic metalens to obtain the at least one electric field component of the incident light at the first designated position as the propagation result.

In an example, the step of determining the phase plane arrangement of the metasurface according to the propagation result and the preset evaluation rule may include:
taking a preset first evaluation function being the minimum as an objective, determining a corresponding phase plane according to the propagation result when the preset first evaluation function is the minimum; the phase plane may include: a phase value required at each coordinate.

In an example, the preset first evaluation function may be constructed according to following information:
a preset focal length;
an electric field component at a specific position when a wavelength of the incident light is λₜ;
where λₜ may be i^{th} wavelength of the incident light.

In an example, the step of matching the phase plane arrangement with each group of the nano-structure unit information in the nano-structure parameter library to determine the structure information of the nano-structure unit adopted correspondingly at each position on the metasurface may include:
matching a phase value required at each coordinate in a phase plane with each piece of nano-structure unit information in the nano-structure parameter library, taking a preset second evaluation function being the minimum as an objective, and determining a phase and a transmittance of a nano-structure unit corresponding to each coordinate on the metasurface when the preset second evaluation function is the minimum; and
determining structure information of the nano-structure unit adopted correspondingly at each coordinate on the metasurface according to the phase and the transmittance of the nano-structure unit corresponding to each coordinate on the metasurface.

In an example, the preset second evaluation function may be constructed according to following information:
a phase required at each coordinate on the metasurface when a wavelength of the incident light is λₜ;
a phase of the nano-structure unit in the nano-structure parameter library when the wavelength of the incident light is λₜ;
a transmittance of the nano-structure unit in the nano-structure parameter library when the wavelength of the incident light is λₜ; and
proportion coefficients configured to adjust importance degrees of the phase and the transmittance in a matching process;
where λₜ is any one wavelength.

In a second aspect, an embodiment of the present disclosure provides an achromatic metalens, a metasurface is designed according to the structure information of the nano-structure unit adopted correspondingly at each position on the metasurface which is determined by the determination method described in the first aspect, and the achromatic metalens with a high numerical aperture is obtained.

In a third aspect, an embodiment of the present disclosure provides a projection display device based on a metalens, and the device includes: the achromatic metalens described in the second aspect, and an optical waveguide structure; light passes through the achromatic metalens and is transmitted/reflected to the optical waveguide structure, and propagates according to a total reflection angle in the optical waveguide structure; and projection light output from the optical waveguide structure may be coupled into human eyes for imaging.

In an example, the optical waveguide structure may include an optical coupling-in apparatus, an optical waveguide substrate, and an optical coupling-out apparatus. The optical coupling-in apparatus and the optical coupling-out apparatus may be disposed at two opposite sides of the optical waveguide substrate respectively; and
the transmitted/reflected light may transmit to the optical coupling-in apparatus, the optical coupling-in apparatus may couple the transmitted/reflected light into the optical waveguide substrate, the transmitted/reflected light propagates in the optical waveguide substrate at a total-reflection-angle to output to the optical coupling-out apparatus, and the optical coupling-out apparatus may couple the transmitted/reflected light into the human eyes for imaging.

In an example, the optical waveguide substrate may include a first surface and a second surface opposite to each other; the transmitted/reflected light may enter the second surface; the optical coupling-in apparatus may be disposed on the first surface, or the optical coupling-in apparatus may be disposed on the second surface.

In a fourth aspect, an embodiment of the present disclosure provides a wearable device, and the wearable device includes: a shell body; and the projection display device, which is described in the third aspect; and the projection display device is arranged in the shell body.

In an example, the wearable device may further include: an eye tracking apparatus. The eye tracking apparatus may include an eye tracking light source, a sensor, and an information processing system; the eye tracking light source may project light to human eyes, the sensor may receive light reflected by the human eyes, and the information processing system may process information in the sensor and perform a human-computer interaction action corresponding to the information in the sensor.

In a fifth aspect, an embodiment of the present disclosure provides an electronic device, and the electronic device includes: at least one processor; and a memory in communication connection with the at least one processor; the memory stores instructions configured to be executed by the at least one processor, and the instructions are executed by the at least one processor to allow the at least one processor to execute the determination method for the achromatic metalens described in the first aspect.

The embodiments of the present disclosure provide a determination method for an achromatic metalens, an achromatic metalens, and an application assembly thereof. The metalens includes a metasurface, and the method includes: obtaining a nano-structure parameter library, the nano-structure parameter library includes: at least one piece of nano-structure unit information; establishing a forward propagation model according to the nano-structure parameter library, and utilizing the forward propagation model for simulating a process in which incident light passes through the metalens to obtain a propagation result; the propagation result includes: at least one electric field component of the incident light at a first designated position; determining phase plane arrangement of the metasurface according to the propagation result and a preset evaluation rule; and matching the phase plane arrangement with each group of the nano-structure unit information in the nano-structure parameter library to determine a geometry size and a shape of a nano-structure unit adopted correspondingly at each position on the metasurface. In this way, a phase plane is optimized according to the propagation result and the evaluation rule, and design objective guidance for the nano-structure units on the metasurface is given in combination with the nano-structure unit information.

It should be understood that, the content described in the present section is not intended to identify key features or important features of the embodiments of the present disclosure, nor is it intended to limit the scope of the present disclosure. The other features of the present disclosure will be easily understood through the specification below.

### BRIEF DESCRIPTION OF THE DRAWINGS

FIG. 1 is a schematic flowchart of a determination method for an achromatic metalens, provided by an embodiment of the present disclosure;

FIG. 2 is a structure diagram of an achromatic metalens provided by an embodiment of the present disclosure;

FIG. 3 is a structure diagram of a nano-structure unit of a metasurface provided by an in embodiment of the present disclosure;

FIGS. 4A-4C are diagrams of an optimized phase plane provided by an embodiment of the present disclosure;

FIGS. 5A-5C are diagrams of a focusing result of an achromatic metalens provided by an embodiment of the present disclosure;

FIG. 6 is a schematic flowchart of a design method for an achromatic metalens, provided by an embodiment of the present disclosure;

FIG. 7 is a structure diagram of a determination apparatus for an achromatic metalens, provided by an embodiment of the present disclosure;

FIG. 8 is a structure diagram of an electronic device provided by an embodiment of the present disclosure;

FIG. 9 is a structure diagram of a projection display device (where light is transmitted through an achromatic metalens to an optical waveguide structure) provided by an embodiment of the present disclosure;

FIG. 10 is a structure diagram of a projection display device (where light is reflected through an achromatic metalens to an optical waveguide structure) provided by an embodiment of the present disclosure;

FIG. 11 is a structure diagram of an optical waveguide structure (where an optical coupling-in apparatus is disposed on a second surface) provided by an embodiment of the present disclosure;

FIG. 12 is a structure diagram of an optical waveguide structure (where an optical coupling-in apparatus is disposed on a first surface) provided by an embodiment of the present disclosure;

FIG. 13 is a structure diagram of an eye tracking apparatus provided by an embodiment of the present disclosure; and

FIG. 14 is a structure diagram of a sensor in an eye tracking apparatus provided by an embodiment of the present disclosure.

### DETAILED DESCRIPTION OF THE EMBODIMENTS

In order to make the objectives, features, and advantages of the present disclosure more apparent and easier to understand, the technical solutions in the embodiments of the present disclosure will be clearly and completely described below with reference to the accompanying drawings in the embodiments of the present disclosure. Apparently, the embodiments described are merely a part rather than all of the embodiments of the present disclosure. On the basis of the embodiments in the present disclosure, all other embodiments obtained by those skilled in the art without creative efforts shall fall within the protection scope of the present disclosure.

In the description below, “some embodiments” are mentioned which describe subsets of all possible embodiments; however, it may be understood that, the “some embodiments” may be the same subset or different subsets of all the possible embodiments, and may be combined with each other in the case of no conflict.

In the description below, the terms “first/second” mentioned are merely used for distinguishing similar objects and do not represent a specific order with regard to the objects. It may be understood that, the “first/second” may be interchanged in a specific order or sequence if allowed, so that the embodiments described herein of the present disclosure can be implemented in an order other than that illustrated or described herein.

Unless otherwise specified, all the technical and scientific terms used in the present disclosure have the same meanings as those commonly understood by those skilled in the art belonging to the present disclosure. The terms used in the present disclosure are merely for the purpose of describing the embodiments of the present disclosure, and are not intended to limit the present disclosure.

It should be understood that, in the embodiments of the present disclosure, the serial numbers of the implementation processes do not imply the execution order, and the execution order for the processes should be determined by functions and internal logics of the processes, and should not constitute any limitation on the implementation processes of the embodiments of the present disclosure.

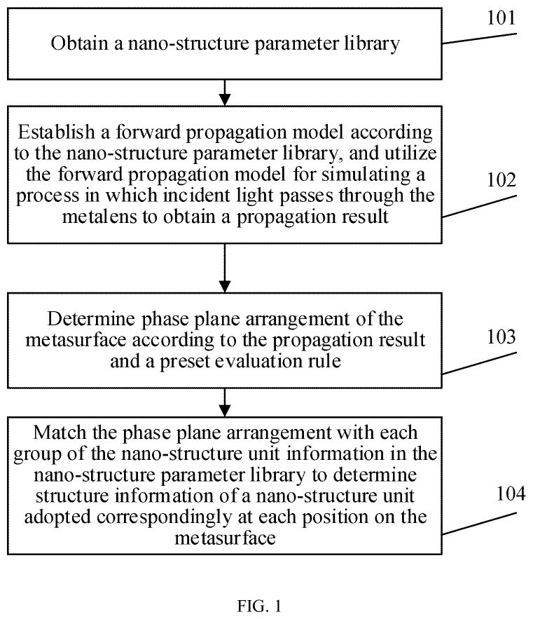

An embodiment of the present disclosure provides a determination method for an achromatic metalens. The metalens includes a metasurface. As shown in FIG. 1, the method includes:
step 101, obtaining a nano-structure parameter library, the nano-structure parameter library includes: at least one piece of nano-structure unit information;
step 102, establishing a forward propagation model according to the nano-structure parameter library, and utilizing the forward propagation model for simulating a process in which incident light passes through the metalens to obtain a propagation result; the propagation result includes: at least one electric field component of the incident light at a first designated position;
step 103, determining phase plane arrangement of the metasurface according to the propagation result and a preset evaluation rule; and
step 104, matching the phase plane arrangement with each group of the nano-structure unit information in the nano-structure parameter library to determine structure information of a nano-structure unit adopted correspondingly at each position on the metasurface.

Specifically, the metalens is also known as a metasurface lens, and specifically may be an achromatic metasurface lens with a high numerical aperture.

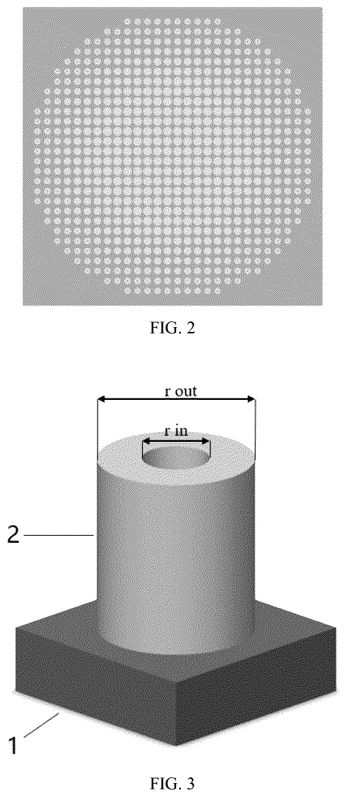

FIG. 2 is a structure diagram of an achromatic metalens provided by an embodiment of the present disclosure. The metasurface of the achromatic metalens includes:
a substrate capable of transmitting light which includes visible light, infrared light, and light with other wave bands; and
a nano-structure unit array arranged on a surface of the substrate.

Nano-structure units are arranged in an array according to a certain rule. The nano-structure unit may be of a nano-pillar structure, such as a circular nano-pillar structure, a hollow nano-pillar structure or the like; or the nano-structure unit may be of other structures obtained in a manner of topological optimization, a neural network or the like. Structural geometry sizes of the nano-structure units are not limited herein.

The material of the substrate may be: any one or more of silicon dioxide, aluminum oxide, or calcium fluoride.

The material of the nano-structure unit with the nano-pillar structure may be: any one or more of titanium oxide, gallium nitride, amorphous silicon, or polycrystalline silicon.

In some embodiments, each piece of the nano-structure unit information may include:
structure information of the nano-structure unit; and
a phase and a transmittance of the nano-structure unit under incidence with different wavelengths;
the structure information includes: a geometry size and a shape of the nano-structure unit.

Specifically, a parameter library of phase distribution, transmittances, and structure parameters under incidence with different wavelengths is obtained by changing the geometry sizes and the shapes of the nano-structure units.

FIG. 3 is a structure diagram of a nano-structure unit of a metasurface provided by an embodiment of the present disclosure. The nano-structure unit 2 may be a hollow nano-pillar; the hollow nano-pillar has an inner diameter (Rin) parameter and an outer diameter (Rout) parameter; and the nano-structure unit 2 is arranged on the substrate 1.

If the nano-structure unit 2 is a circular nano-pillar, the nano-structure unit 2 has the Rout parameter.

The nano-structure parameter library is obtained by designing the nano-structure units having a plurality of the Rin parameters and the Rout parameters, or the Rout parameters, and measuring the phases and the transmittances of the nano-structure units under incidence with different wavelengths. Any one existing measurement method for the phases and the transmittances may be adopted herein, and the measurement manner is not limited.

The phases and the transmittances of the nano-structure units with different structures are also different at different wavelengths, and the phase and the transmittance of each nano-structure unit are changed by changing the Rout parameter.

In some embodiments, the establishing the forward propagation model according to the nano-structure parameter library, and utilizing the forward propagation model for simulating the process in which the incident light passes through the metalens to obtain the propagation result includes:
establishing scattering field distribution of each nano-structure unit at different wavelengths of the incident light according to a phase and a transmittance of each nano-structure unit in the nano-structure parameter library;
establishing the forward propagation model according to the scattering field distribution of each nano-structure unit at different wavelengths of the incident light; and
adopting a Green function method, utilizing the forward propagation model for simulating the process in which the incident light passes through the metalens to obtain at least one electric field component of the incident light at the first designated position as the propagation result.

Specifically, the scattering field distribution of each nano-structure unit at different wavelengths of the incident light is established according to the phase and the transmittance of each nano-structure unit in the nano-structure parameter library, and recorded as s (xᵢ, yᵢ, zᵢ, λᵢ); where λᵢ is the i^{th} wavelength of the incident light; that is, s is the scattering field distribution at a coordinate (xᵢ, yᵢ, zᵢ) on the metasurface when the wavelength of the incident light is λᵢ; and herein, any one existing manner may be adopted for establishing the scattering field distribution, and a method specifically adopted is not limited.

The forward propagation model is established according to the scattering field distribution of each nano-structure unit at different wavelengths of the incident light, as shown in a formula (1):

$$E ( {x}_{o} , {y}_{o} , {z}_{o} , {λ}_{i} ) = \int \int s ( {x}_{i} , {y}_{i} , {z}_{i} , {λ}_{i} ) G ( {x}_{i} , {y}_{i} , {z}_{i} , {x}_{o} , {y}_{o} , {z}_{o} , {λ}_{i} ) {dx}_{i} {dy}_{i} \qquad ( 1 )$$

where E is an electric field component at a first designated position (xₒ, yₒ, zₒ) when the wavelength of the incident light is λᵢ;
λᵢ is the i^{th} wavelength of the incident light; and a specific value is determined based according to an actual condition;
s is the scattering field distribution at a coordinate (xᵢ, yᵢ, zᵢ) on the metasurface when the wavelength of the incident light is λᵢ; and
G is a Hankel function, and is related to the wavelength λᵢ of the incident light, the coordinate (xₒ, yₒ, zₒ) of the first designated position, and the coordinate (xᵢ, yᵢ, zᵢ) on the metasurface.

Herein, the forward propagation model is calculated by means of the Green function method, and intensity distribution at the first designated position when the incident light passes through the metalens is obtained. The process may also be calculated by means of a FDTD algorithm and a vector angular spectrum method, which will not be repeated herein.

It is assumed that, the method provided by the embodiment of the present disclosure is used for realizing a design method for an achromatic metalens with a high numerical aperture, a working wave band is 400 nm to 700 nm, a diameter of the metalens is 200 μm, a focal length is 100 μm, the structure of the achromatic metalens is shown in FIG. 2, and herein, with regard to the metalens required above, a process in which incident light passes through the metalens is simulated, and calculated by means of the above formula (1).

In some embodiments, the determining the phase plane arrangement of the metasurface according to the propagation result and the preset evaluation rule includes:
taking a preset first evaluation function being the minimum as an objective, determining a corresponding phase plane according to the propagation result when the first evaluation function is the minimum; the phase plane includes: a phase value required at each coordinate (xᵢ, yᵢ).

The first evaluation function is constructed according to following information:
a preset focal length;
an electric field component at a specific position when a wavelength of the incident light is λᵢ.

Specifically, the first evaluation function is provided, as shown in a formula (2) below:

$${\sum }_{i = 1}^{N} ( max {\vert E ( 0 , 0 , {z}_{o} , {λ}_{i} ) \vert}^{2} - {f}_{design} ) \qquad ( 2 )$$

where f_{design} is a preset focal length;
N is a total number of the wavelengths of the incident light;
λᵢ is the i^{th} wavelength of the incident light, and a specific value is determined according to an actual condition; for example, λᵢ may be 450 nm, 532 nm, and 632 nm; and
E represents an electric field component at a specific position (0, 0, zₒ) when the wavelength of the incident light is λᵢ.

Herein, (0, 0, zₒ) specifically refers to a center point when coordinate values of x and y are 0. By determining zₒ when the first evaluation function is the minimum and determining phase values required for (xᵢ, yᵢ) when the z-axis coordinate is zₒ, a corresponding phase plane when the first evaluation function is the minimum is obtained, and recorded as φ_{des}(xᵢ, yᵢ, λᵢ).

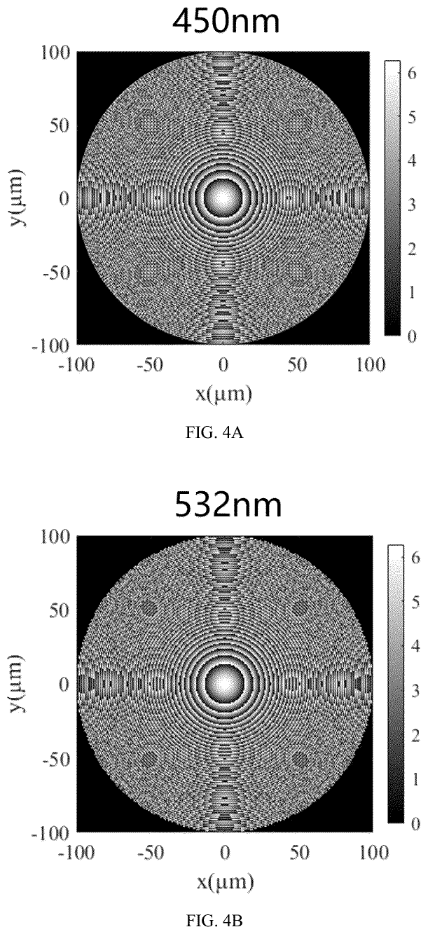

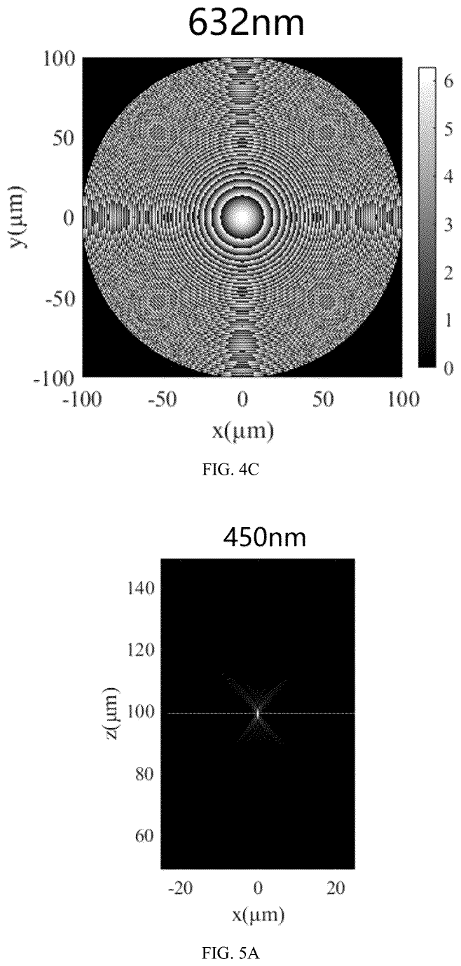

FIGS. 4A-4C are diagrams of phase plane distribution obtained through an optimization method, provided by an embodiment of the present disclosure. Through a method of optimizing phase arrangement, the phase plane distribution shown in FIGS. 4A-4C may be obtained, and recorded as φ_{des}(xᵢ, yᵢ, λᵢ). For example, λᵢ specifically may be 450 nm, 532 nm, and 632 nm in a range of 450 nm to 632 nm.

In some embodiments, the matching the phase plane arrangement with each group of the nano-structure unit information in the nano-structure parameter library to determine the structure information of the nano-structure unit adopted correspondingly at each position on the metasurface includes:
matching a phase value required at each coordinate in a phase plane with each piece of nano-structure unit information in the nano-structure parameter library, taking a preset second evaluation function being the minimum as an objective, and determining a phase and a transmittance of a nano-structure unit corresponding to each coordinate on the metasurface when the second evaluation function is the minimum; and
determining structure information of the nano-structure unit adopted correspondingly at each coordinate on the metasurface according to the phase and the transmittance of the nano-structure unit corresponding to each coordinate on the metasurface.

The second evaluation function is constructed according to following information:
a phase required at each coordinate on the metasurface when a wavelength of the incident light is λₜ;
a phase of the nano-structure unit in the nano-structure parameter library when the wavelength of the incident light is λₜ;
a transmittance of the nano-structure unit in the nano-structure parameter library when the wavelength of the incident light is λₜ; and
proportion coefficients configured to adjust importance degrees of the phase and the transmittance in a matching process;
where λₜ is any one wavelength.

Herein, the coordinates of the phase plane actually are the coordinates of the metasurface, and the phase required at each coordinate on the metasurface is the phase required at each coordinate on the phase plane.

Specifically, the obtained phase plane distribution is matched with the phases in the nano-structure parameter library, so that each position on the metasurface has a phase closest to φ_{des} (xᵢ, yᵢ, λᵢ); and meanwhile, in order to achieve a high transmittance, the matching is carried out according to a formula (3) below:

$$min ( α {\sum }_{t = 1}^{n} \vert ( {φ}_{des} ( {x}_{i} , {y}_{i} , {λ}_{t} ) - {φ}_{real} ( {λ}_{t} ) ) \vert - β {\sum }_{t = 1}^{n} {T}_{real} ( {λ}_{t} ) ) \qquad ( 3 )$$

In the formula, φ_{des} (xᵢ, yᵢ, λₜ) represents the phase required at (xᵢ, yᵢ) on the metasurface when the wavelength of the incident light is λₜ, n is a total number of the wavelengths of the incident light;
φᵣₑₐₗ (λₜ) represents a phase of a certain nano-structure unit in the nano-structure parameter library when the wavelength of the incident light is λₜ;
Tᵣₑₐₗ (λₜ) represents a transmittance of a certain nano-structure unit in the nano-structure parameter library when the wavelength of the incident light is λₜ,
α and β are proportion coefficients respectively, which are configured to adjust importance degrees of the phase and the transmittance in the matching process; the larger the proportion coefficients, the more important the influence of the parameters; and values of α and β are not limited, and specifically determined according to an actual need.

The corresponding metasurface structure of the achromatic metalens may be obtained according to the above process, so that achromatic focusing on a plurality of wavelengths is realized.

In some embodiments, the method further includes:
designing the metasurface according to the determined structure information (a geometry size and a shape) of the nano-structure unit adopted correspondingly at each position on the metasurface, and obtaining an achromatic metalens with a high numerical aperture.

According to the method provided by the embodiment of the present disclosure, an optimization design is carried out on the phase plane by means of an optimization algorithm, so as to obtain the optimal phase plane of the achromatic metalens; and a feedback on the phases of the required nano-structure units is given according to an optimization result, and then directional optimization is carried out on the parameters of the nano-structure units. Through a topological optimization design for the phase plane, it is avoided that a limitation of the achromatic metalens on the numerical aperture is realized in a manner of dispersion compensation, and achromatic focusing with a high numerical aperture can be realized. The achromatic metalens may be used for a consumer-grade electronic imaging lens, and may reduce a thickness and a weight of the lens.

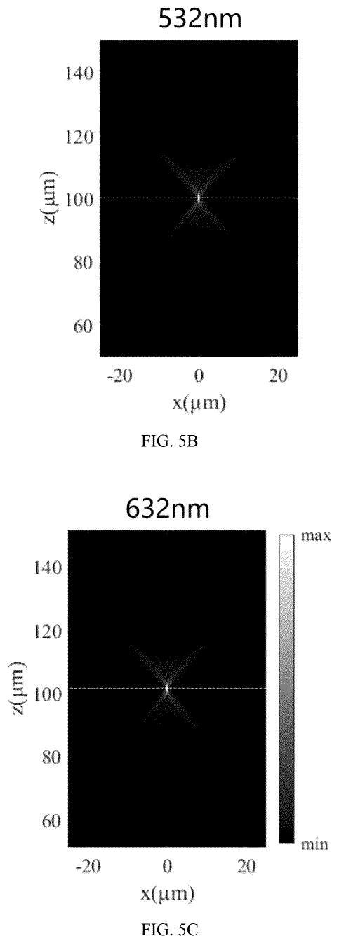

FIGS. 5A-5C are diagrams of a focusing result of an achromatic metalens provided by an embodiment of the present disclosure. As shown in FIGS. 5A-5C, under incidence with wavelengths of 450 nm, 532 nm, and 632 nm, the achromatic metalens has almost identical focal lengths which are 99 μm, 100.2 μm, and 101.2 μm respectively, and may meet an achromatic requirement.

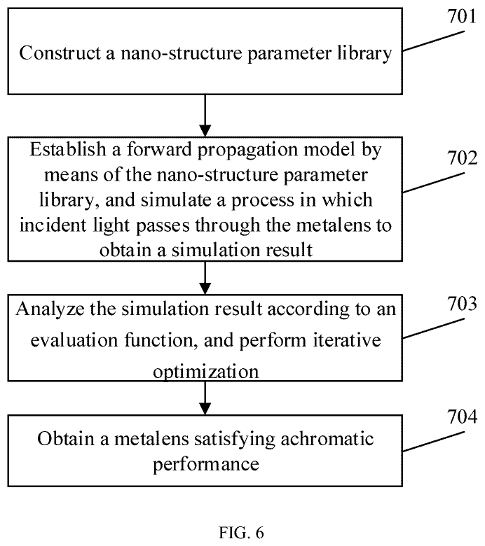

FIG. 6 is a schematic flowchart of a design method for an achromatic metalens, provided by an embodiment of the present disclosure. As shown in FIG. 6, the method includes:
step 701, obtaining phases and transmittances of nano-structure units under incidence of incident light with different wavelengths by changing geometry sizes and shapes of the nano-structure units; and constructing a nano-structure parameter library according to the geometry sizes, the shapes, the phases, and the transmittances of the nano-structure units;
step 702, establishing a forward propagation model by means of the nano-structure parameter library, and simulating a process in which incident light passes through the metalens to obtain a simulation result;
step 703, analyzing the simulation result according to an evaluation function, and performing iterative optimization.

Herein, the above formula 2 may be adopted for the evaluation function, and corresponding explanation in the method shown in FIG. 1 is referred to for a specific method, and the specific method will not be repeated herein.

Herein, the method may further include:
if a good result cannot be realized according to the current nano-structure parameter library, an optimization design may further be carried out on the geometry sizes and the shapes of the nano-structure units according to a required phase delay to supplement the nano-structure parameter library. The step is an optional step, and whether the step is executed is determined according to an actual condition.
Step 704, obtaining a metalens satisfying achromatic performance.

Specifically, an achromatic metalens is constructed according to the obtained optimal solution of the geometry sizes, the shapes and the arrangement of the nano-structure units. Specifically, the explanation in the method shown in FIG. 1 may be referred to, and the content will not be repeated herein.

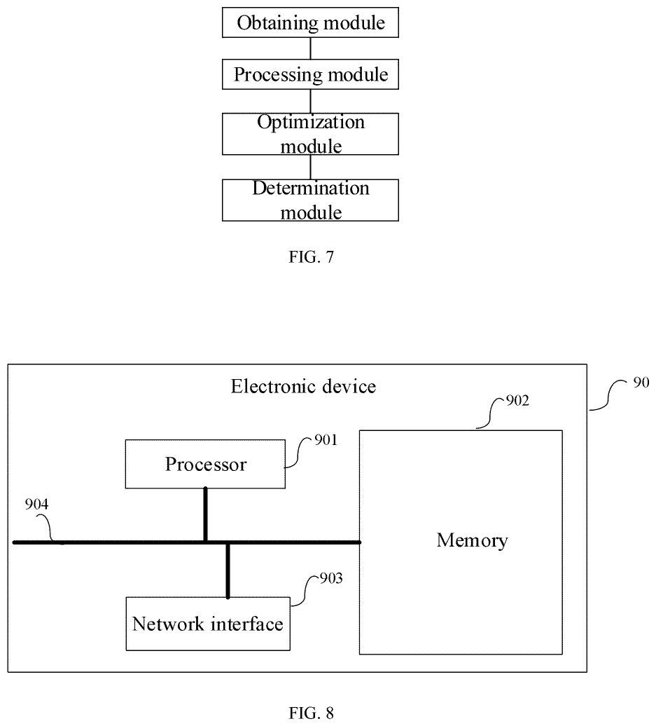

FIG. 7 is a structure diagram of a determination apparatus for an achromatic metalens, provided by an embodiment of the present disclosure. As shown in FIG. 7, the metalens includes a metasurface, and the apparatus includes:
an obtaining module configured to obtain a nano-structure parameter library, the nano-structure parameter library includes: at least one piece of nano-structure unit information;
a processing module configured to establish a forward propagation model according to the nano-structure parameter library, and utilize the forward propagation model for simulating a process in which incident light passes through the metalens to obtain a propagation result; the propagation result includes: at least one electric field component of the incident light at a first designated position;
an optimization module configured to determine phase plane arrangement of the metasurface according to the propagation result and a preset evaluation rule; and
a determination module configured to match the phase plane arrangement with each group of the nano-structure unit information in the nano-structure parameter library to determine structure information of a nano-structure unit adopted correspondingly at each position on the metasurface.

It may be understood that, when the determination apparatus for the achromatic metalens, which is provided by the above embodiment realizes the corresponding determination method for the achromatic metalens, the above processing may be distributed to be completed by different program modules as needed, so that all or a part of the processing described above is completed. In addition, the apparatus provided by the above embodiment and the corresponding methods belong to the same concept, and a specific realization process is detailed in the method embodiments, and will not be repeated herein.

An embodiment of the present disclosure provides a computer-readable storage medium having stored therein executable instructions, when the executable instructions are executed by a processor, the processor will be triggered to execute the determination method for the achromatic metalens provided by the embodiments of the present disclosure.

In some embodiments, the computer-readable storage medium may be a ferroelectric RAM (FRAM), a read-only memory (ROM), a programmable read-only memory (PROM), an erasable programmable ROM (EPROM), an electrically erasable programmable read-only memory (EEPROM), a flash memory, a magnetic surface memory, an optical disc, a CD-ROM or other memories; and the computer-readable storage medium may also be various devices including one or any combination of the above memories.

In some embodiments, the executable instructions may be in a form of programs, software, software modules, scripts, or codes, and written by programming languages (including compiled or interpreted languages, or declarative or procedural languages) in any form, and may be deployed in any form, including as independent programs or as modules, models, subroutines, or other units suitable for being used in a computing environment.

As an example, the executable instructions may be deployed to be executed in one computing device, or be executed in a plurality of computing devices disposed at a place, or be executed in a plurality of computing devices which are distributed at a plurality of places and interconnected through a communication network.

An embodiment of the present disclosure provides a computer program product, and the computer program product includes a computer program or instructions; when the computer program or instructions are executed by a processor, the determination method for the achromatic metalens provided by the present disclosure is realized.

FIG. 8 is a structure diagram of an electronic device provided by an embodiment of the present disclosure. As shown in FIG. 8, an electronic device 90 includes: a processor 901 and a memory 902 configured to store a computer program capable of being run in the processor; and the processor 901 is configured to execute the determination method for the achromatic metalens provided by the embodiments of the present disclosure when the computer program is run.

In practical application, the electronic device 90 may further include: at least one network interface 903. Assemblies in the electronic device 90 are coupled together through a bus system 904. It may be understood that, the bus system 904 is configured to realize connection and communication among these assemblies. The bus system 904 includes not only a data bus, but also a power bus, a control bus, and a state signal bus. However, for the sake of clarity, all these buses are labeled as the bus system 904 in FIG. 8. There may be at least one processor 901. The network interface 903 is used for communication in a wired or wireless manner between the electronic device 90 and other devices.

The memory 902 in the embodiment of the present disclosure is configured to store various types of data to support the operation of the electronic device 90.

The above method disclosed by the embodiments of the present disclosure may be applied to the processor 901 or realized by the processor 901. The processor 901 may be an integrated circuit chip with signal processing capability. In a realization process, the steps of the above method may be completed through integrated logic circuits of/in hardware, or instructions in a form of software in the processor 901. The above processor 901 may be a general-purpose processor, a digital signal processor (DSP), or other programmable logic elements, discrete gates or transistor logic elements, discrete hardware assemblies, or the like. The processor 901 may realize or execute the methods, steps, and logical diagrams which are disclosed in the embodiments of the present disclosure. The general-purpose processor may be a micro-processor or any conventional processor, or the like. The steps of the method disclosed by the embodiments of the present disclosure may be directly embodied to be executed by a hardware decoding processor, or be executed by a combination of a hardware module and a software module in the decoding processor. The software module may be disposed in a storage medium, and the storage medium is disposed in the memory 902. The processor 901 reads information in the memory 902 and completes the steps of the above method in a manner of combining with hardware of the processor 901.

In some embodiments, the electronic device 90 may be realized by one or more application specific integrated circuits (ASICs), DSPs, programmable logic devices (PLDs), complex programmable logic devices (CPLDs), field-programmable gate arrays (FPGAs), general-purpose processors, controllers, micro-controller units (MCUs), micro-processors, or other electronic components, and are configured to execute the above method.

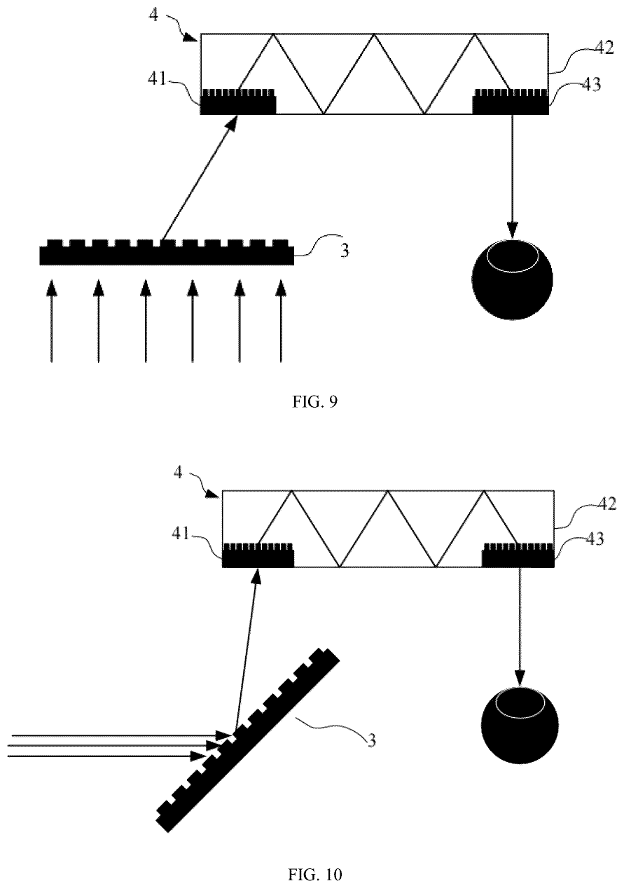

Referring to FIG. 9 and FIG. 10, an embodiment of the present disclosure further provides a projection display device based on a metalens, and the device includes: an achromatic metalens 3 which is obtained through processing by any one of the above methods, and an optical waveguide structure 4. Light passes through the achromatic metalens 3 and is transmitted/reflected to the optical waveguide structure 4, and propagates according to a total reflection angle in the optical waveguide structure 4, and projection light output from the optical waveguide structure 4 is coupled into human eyes for imaging.

In an embodiment, the optical waveguide structure 4 includes an optical coupling-in apparatus 41, an optical waveguide substrate 42, and an optical coupling-out apparatus 43; and the optical coupling-in apparatus 41 and the optical coupling-out apparatus 43 are disposed at two opposite sides of the optical waveguide substrate 42 respectively.

The transmitted/reflected light transmits to the optical coupling-in apparatus 41, the optical coupling-in apparatus 41 couples the transmitted/reflected light into the optical waveguide substrate 42, the transmitted/reflected light propagates in the optical waveguide substrate 42 at a total-reflection-angle to output to the optical coupling-out apparatus 43, and the optical coupling-out apparatus 43 couples the transmitted/reflected light into the human eyes for imaging.

The optical coupling-in apparatus 41 includes one or a group of metalenses, and can adjust an angle of the transmitted/reflected light, so that the transmitted/reflected light can be input into the optical waveguide substrate 42 according to a critical angle, and propagated forwards along total reflection in the optical waveguide substrate 42. Angle modulation of the optical coupling-in apparatus 41 for projection light (such as the above transmitted/reflected light) meets a formula (4) below:

$$∅ ( {θ}_{x} , {θ}_{y} ) = \frac{{n}_{2}}{{n}_{1}} \qquad ( 4 )$$

where Ø (θₓ, θ_{y}) is an angle of the projection light emitted by the optical coupling-in apparatus 41, n₁ is a refractive index of the projection light in air, and n₂ is a refractive index of the projection light in the optical waveguide substrate 42.

The optical waveguide substrate is usually made of materials with a high refractive index, such as glass or plastic, and has a central core and a surrounding outer layer. When the light enters the optical waveguide substrate, due to the effect of total reflection, the light is reflected on an interface between the central core and the outer layer, and then is transmitted along the optical waveguide substrate. The total reflection may be realized in the optical waveguide substrate by controlling an angle and a position of the incident light, and then a transmission path and a final display position of the light are controlled.

An achromatic design is adopted for the optical coupling-in apparatus and the optical coupling-out apparatus, and a chromatic aberration of the projection light can be eliminated.

The optical waveguide substrate plays an important role in AR glasses, and may enable light from a display or a projector to be guided onto a metalens or a reflector near eyes, and then observation for virtual images is realized. High-quality augmented reality experience may be realized by reasonably designing the optical waveguide structure and controlling an incident angle of the light.

In an embodiment, the optical waveguide substrate 42 includes a first surface 401 and a second surface 402 which are opposite to each other. The second surface 402 is a surface where the transmitted/reflected light enters. The optical coupling-in apparatus 41 is disposed on the first surface 401, or the optical coupling-in apparatus is disposed on the second surface 402.

FIG. 11 is a structure diagram of an optical waveguide structure (where an optical coupling-in apparatus 41 is disposed on a second surface 402) provided by an embodiment of the present disclosure. As shown in FIG. 11, the optical coupling-in apparatus is disposed on the second surface.

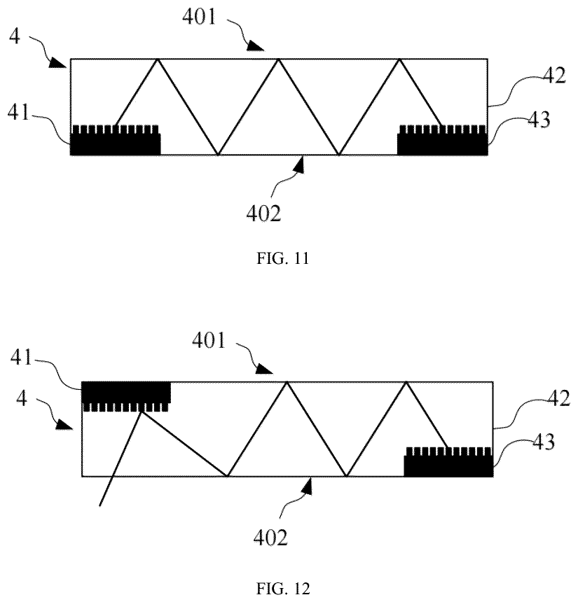

FIG. 12 is a structure diagram of an optical waveguide structure (where an optical coupling-in apparatus 41 is disposed on a first surface 401) provided by an embodiment of the present disclosure. As shown in FIG. 12, the optical coupling-in apparatus is disposed on the first surface 401.

An embodiment of the present disclosure further provides a wearable device. The wearable device includes a shell body; and the projection display device based on the metalens, which is described in any one of the above embodiments. The projection display device based on the metalens is arranged in the shell body.

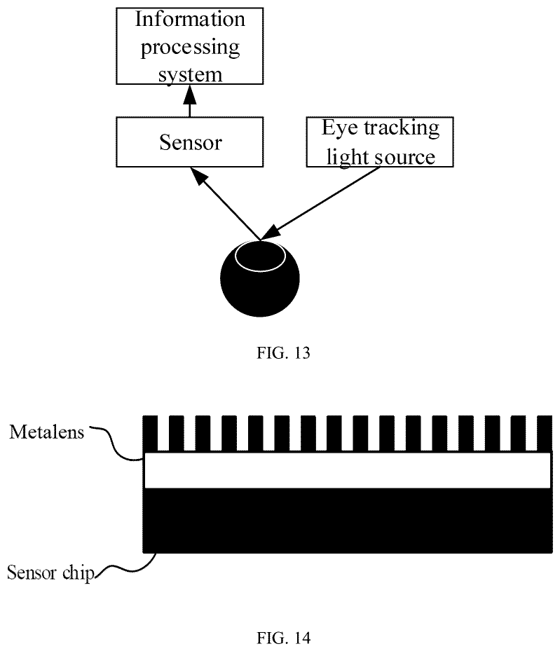

Referring to FIG. 13, the wearable device further includes an eye tracking apparatus, which includes an eye tracking light source, a sensor, and an information processing system. The eye tracking light source projects light to human eyes, the sensor receives light reflected by the human eyes, and the information processing system processes information in the sensor and performs a corresponding human-computer interaction action, so that intelligence of AR glasses is improved.

Referring to FIG. 14, according to the sensor of the eye tracking apparatus disclosed by the embodiment of the present disclosure, the metalens and a sensor chip are integrated into one element by means of a semiconductor process, so that an integration degree and a machining degree for the element are greatly increased, wearability of the AR glasses is improved, and the cost is reduced.

The wearable device includes a head-mounted display device, such as AR glasses or an AR helmet, and at this moment, the projection display device, for example, may form an AR projection light machine. Certainly, the wearable device may also be a VR product and the like, which is not limited in the embodiment of the present disclosure.

In addition, the projection display device provided by the embodiments of the present disclosure may also be used for other types of projection apparatuses such as home projectors and vehicle-mounted projectors, which is not limited in the embodiment of the present disclosure.

It should be understood that, the steps may be reordered, added, or deleted by using the flows in various forms, which are shown above. For example, the steps described in the present disclosure may be executed in parallel, or executed sequentially, or executed in different orders, as long as a desired result of the technical solution disclosed by the embodiments of the present disclosure can be realized, and the manner is not limited in the present disclosure herein.

In addition, the terms “first” and “second” are merely used for a purpose of description, and cannot be understood as indicating or implying relative importance or implying the number of the technical features indicated. Therefore, the features that are limited to have “first” and “second” may explicitly or implicitly include at least one of these features. In the description of the present disclosure, the meaning of “a plurality of” refers to two or more, unless otherwise specifically limited.

The above is merely a specific implementation manner of the present disclosure, however, the protection scope of the present disclosure is not limited thereto, and any skilled in the art may easily conceive of changes or substitutions within the technical scope disclosed by the present disclosure, and all those changes or substitutions should be included in the protection scope of the present disclosure. Therefore, the protection scope of the present disclosure should be based on the protection scope of the claims.

1. A determination method for an achromatic metalens, wherein the achromatic metalens comprises a metasurface, and the determination method comprises:
obtaining a nano-structure parameter library; wherein the nano-structure parameter library comprises: at least one piece of nano-structure unit information;
establishing a forward propagation model according to the nano-structure parameter library, and utilizing the forward propagation model for simulating a process in which incident light passes through the achromatic metalens to obtain a propagation result; wherein the propagation result comprises: at least one electric field component of the incident light at a first designated position;
determining phase plane arrangement of the metasurface according to the propagation result and a preset evaluation rule; and
matching the phase plane arrangement with each group of the nano-structure unit information in the nano-structure parameter library to determine structure information of a nano-structure unit adopted correspondingly at each position on the metasurface.

2. The determination method according to claim 1, wherein each piece of the nano-structure unit information comprises:
the structure information of the nano-structure unit; and
a phase and a transmittance of the nano-structure unit under incidence with different wavelengths;
wherein the structure information comprises: a geometry size and a shape of the nano-structure unit.

3. The determination method according to claim 1, wherein the step of establishing the forward propagation model according to the nano-structure parameter library, and utilizing the forward propagation model for simulating the process in which the incident light passes through the achromatic metalens to obtain the propagation result comprises:
establishing scattering field distribution of each nano-structure unit at different wavelengths of the incident light according to a phase and a transmittance of each nano-structure unit in the nano-structure parameter library;
establishing the forward propagation model according to the scattering field distribution of each nano-structure unit at different wavelengths of the incident light; and
adopting a Green function method, utilizing the forward propagation model for simulating the process in which the incident light passes through the achromatic metalens to obtain the at least one electric field component of the incident light at the first designated position as the propagation result.

4. The determination method according to claim 1, wherein the step of determining the phase plane arrangement of the metasurface according to the propagation result and the preset evaluation rule comprises:
taking a preset first evaluation function being the minimum as an objective, determining a corresponding phase plane according to the propagation result when the preset first evaluation function is the minimum; wherein the phase plane comprises: a phase value required at each coordinate.

5. The determination method according to claim 4, wherein the preset first evaluation function is constructed according to following information:
a preset focal length;
an electric field component at a specific position when a wavelength of the incident light is λᵢ,
wherein λᵢ is i^{th} wavelength of the incident light.

6. The determination method according to claim 1, wherein the step of matching the phase plane arrangement with each group of the nano-structure unit information in the nano-structure parameter library to determine the structure information of the nano-structure unit adopted correspondingly at each position on the metasurface comprises:
matching a phase value required at each coordinate in a phase plane with each piece of nano-structure unit information in the nano-structure parameter library, taking a preset second evaluation function being the minimum as an objective, and determining a phase and a transmittance of a nano-structure unit corresponding to each coordinate on the metasurface when the preset second evaluation function is the minimum; and
determining structure information of the nano-structure unit adopted correspondingly at each coordinate on the metasurface according to the phase and the transmittance of the nano-structure unit corresponding to each coordinate on the metasurface.

7. The determination method according to claim 6, wherein the preset second evaluation function is constructed according to following information:
a phase required at each coordinate on the metasurface when a wavelength of the incident light is λₜ;
a phase of the nano-structure unit in the nano-structure parameter library when the wavelength of the incident light is λₜ;
a transmittance of the nano-structure unit in the nano-structure parameter library when the wavelength of the incident light is λₜ; and
proportion coefficients configured to adjust importance degrees of the phase and the transmittance in a matching process;
wherein λₜ is any one wavelength.

8. An achromatic metalens, wherein a metasurface is designed according to the structure information of the nano-structure unit adopted correspondingly at each position on the metasurface determined by the determination method according to claim 1, and the achromatic metalens with a high numerical aperture is obtained.

9. A projection display device based on a metalens, comprising the achromatic metalens according to claim 8, and an optical waveguide structure;
wherein light passes through the achromatic metalens and is transmitted/reflected to the optical waveguide structure, and propagates according to a total reflection angle in the optical waveguide structure; and projection light output from the optical waveguide structure is coupled into human eyes for imaging.

10. The projection display device according to claim 9, wherein the optical waveguide structure comprises an optical coupling-in apparatus, an optical waveguide substrate, and an optical coupling-out apparatus; and the optical coupling-in apparatus and the optical coupling-out apparatus are disposed at two opposite sides of the optical waveguide substrate respectively; and
the transmitted/reflected light transmits to the optical coupling-in apparatus, the optical coupling-in apparatus couples the transmitted/reflected light into the optical waveguide substrate, the transmitted/reflected light propagates in the optical waveguide substrate at a total-reflection-angle to output to the optical coupling-out apparatus, and the optical coupling-out apparatus couples the transmitted/reflected light into the human eyes for imaging.

11. The projection display device according to claim 10, wherein the optical waveguide substrate comprises a first surface and a second surface opposite to each other, wherein the transmitted/reflected light enters the second surface; wherein the optical coupling-in apparatus is disposed on the first surface, or the optical coupling-in apparatus is disposed on the second surface.

12. A wearable device, comprising:
a shell body; and
the projection display device according to claim 9, wherein the projection display device is arranged in the shell body.

13. The wearable device according to claim 12, further comprising: an eye tracking apparatus; wherein the eye tracking apparatus comprises an eye tracking light source, a sensor, and an information processing system; wherein the eye tracking light source projects light to human eyes, the sensor receives light reflected by the human eyes, and the information processing system processes information in the sensor and performs a human-computer interaction action corresponding to the information in the sensor.

14. An electronic device, comprising:
at least one processor; and
a memory in communication connection with the at least one processor;
wherein the memory stores instructions configured to be executed by the at least one processor, and the instructions are executed by the at least one processor to allow the at least one processor to execute the determination method according to claim 1.
